(19) United States
(12) Patent Application Publication
(10) Pub. No.: US 2012/0171566 A1
(43) Pub. Date: Jul. 5, 2012

(54) ELECTRODE FOR LITHIUM ION BATTERY AND METHOD FOR PRODUCING SAME

(75) Inventors: Hideya Yoshitake, Minato-ku (JP); Kenji Fukuda, Ube-shi (JP); Hirofumi Takemoto, Ube-shi (JP)

(73) Assignee: UBE INDUSTRIES, LTD., Ube-shi, Yamaguchi (JP)

(21) Appl. No.: 13/260,873

(22) PCT Filed: Mar. 29, 2010
(86) PCT No.: PCT/JP2010/055583

§ 371 Date: Nov. 3, 2011

(30) Foreign Application Priority Data
Mar. 31, 2009 (JP) 2009-086198

(51) Int. Cl. H01M 4/66; H01M 4/04; H01B 1/04

(52) U.S. Cl. 429/209; 252/502; 427/122

(57) ABSTRACT

There is disclosed an electrode for a lithium-ion battery containing (a) a fine fibrous carbon having a diameter of less than 100 nm and (b) a fibrous carbon having a diameter of 100 nm or more and/or (c) a non-fibrous conductive carbon as an electrical conducting material. This electrode for a lithium-ion battery has a small electrode surface resistance, an improved discharge capacity and excellent cycle properties.

### TECHNICAL FIELD

The present invention relates to an electrode for a lithium-ion battery, particularly an electrode containing fibrous carbon as an electrical conducting material.

### BACKGROUND ART

A positive electrode in a lithium-ion battery generally contains a positive electrode active material such as lithium complex oxide, an electrical conducting material (also called as a “conductive auxiliary”) such as carbon black and a binder, and is prepared by applying a slurry solution containing these materials to a collector. For improving battery performance, it has been suggested that to a positive electrode is added a vapor-grown carbon fiber as an electrical conducting material alone or in combination with a non-fibrous carbon (Patent Reference No. 1: Japanese Laid-Open publication No. 2000-58066, and Patent Reference No. 2: Japanese Laid-Open publication No. 2006-127823).

### PATENT REFERENCES

Patent Reference No. 1: Japanese Laid-Open publication No. 2000-58066.
Patent Reference No. 2: Japanese Laid-Open publication No. 2006-127823.

### SUMMARY OF INVENTION

### Problem to be Solved by the Invention

A fibrous carbon coexisting with an active material allows for forming conduction network between the active material, resulting in improvement in battery conductivity, cycle properties, rate properties and a battery capacity. However, a conventional vapor grown carbon fiber generally has a fiber diameter as large as 100 nm or more (Patent Reference Nos. 1 and 2 have no descriptions about a fiber diameter), leading to reduction in the number of fibers playing a role of an electrical conducting material. Consequently, a proportion of fibers in contact with an active material is small, so that a vapor-grown carbon fiber is ineffective as an electrical conducting material for achieving an uniform electrode potential.

In a fibrous carbon having a large aspect ratio, fibers are mutually entangled and thus, it is generally difficult to homogeneously disperse the fibers in active material. In particular, when a coating slurry is water-based, fiber agglomeration tends to occur during drying and the fibers cannot be uniformly dispersed in the electrode after drying. Particularly, in a fine fibrous carbon having a diameter of less than 100 nm, this tendency is prominent and further increasing an aspect ratio of a fiber for improving conductivity tends to accelerate further fiber agglomeration. Fibers can be dispersed to some extent by using an active material as a dispersion medium and thoroughly kneading fibrous carbon with the active material, but dispersion with stirring with a large shear stress in the coexistence with the active material causes problems such as particle disruption and peeling of a surface-treated layer in the active material.

It has been, therefore, needed that an electrical conducting material is contained in an amount as small as possible in an electrode for a lithium-ion battery and the electrical conducting material is well dispersed within the electrode.

An objective of the present invention is to provide an electrode for a lithium-ion battery with a small electrode surface resistance, an improved discharge capacity and good cycle properties.

### Means for Solving Problem

The present invention relates to the following items. Herein, for distinguishing between (a) a fine fibrous carbon having a diameter of less than 100 nm and (b) a fibrous carbon having a diameter of 100 nm or more, these are sometimes referred to as a “fine fibrous carbon (a)” and a “fibrous carbon (b)”, respectively. Furthermore, (c) a non-fibrous electrically conductive carbon is sometimes referred to as a “conductive carbon (c)”.

1. An electrode for a lithium-ion battery comprising, as an electrical conducting material,

(a) a fine fibrous carbon having a diameter of less 100 nm, and

(b) a fibrous carbon having a diameter of 100 nm or more and/or

(c) a non-fibrous conductive carbon.

2. The electrode for a lithium-ion battery according to the above item 1, wherein the (b) fibrous carbon having a diameter of 100 nm or more is a multilayer carbon nanotube synthesized by vapor phase growth.
3. The electrode for a lithium-ion battery according to the above item 1, wherein the (c) non-fibrous conductive carbon is selected from the group consisting of Ketjen Black (registered trademark, from Ketjen Black International Company), acetylene black, and SUPER P(registered trademark, from TIMCAL Graphite & Carbon Inc.), SUPER 5, KS-4 and KS-6 (these three are tradenames, from TIMCAL Graphite & Carbon Inc.).
4. The electrode for a lithium-ion battery according to any one of the above items 1 to 3, wherein a diameter of the (a) fine fibrous carbon is 5 to 20 nm.
5. The electrode for a lithium-ion battery according to any of the above items 1 to 4, wherein the (a) fine fibrous carbon is a fibrous carbon produced by a disproportionation reaction of carbon monoxide.
6. A process for manufacturing an electrode for a lithium-ion battery, comprising mixing an electrical conducting material containing

(a) a fine fibrous carbon having a diameter of less than 100, and

(b) a fibrous carbon having a diameter of 100 nm or more and/or

(c) a non-fibrous conductive carbon,

with an active material.
7. The process according to the above item 6, wherein the process comprising

a step of producing the electrode using the (a) fine fibrous carbon having a diameter of less than 100 nm, wherein the (a) fine fibrous carbon is a short-fibered carbon prepared by applying shear stress, and/or

a step of shortening the (a) fine fibrous carbon having a diameter of less than 100 nm successively by applying shear stress during preparation an electrode slurry including the (a) fine fibrous carbon having a diameter of less than 100 nm by kneading.

8. The process according to the above item 6 or 7, comprising the steps of

dispersing the (a) fine fibrous carbon having a diameter of less than 100 nm in a solvent to prepare a dispersion solution A;

blending the dispersion solution A and an active material to prepare an electrode coating dispersion, wherein the (b) fibrous carbon having a diameter of 100 nm or more and/or the (c) non-fibrous conductive carbon are contained in the dispersion solution, and/or mixed during preparing the electrode coating dispersion; and

applying the electrode coating dispersion.

9. The process according to the above item 8, wherein the solvent is water.
10. The process according to the above item 8, wherein the solvent is an organic solvent.
11. The process according to any one of the above items 6 to 10, wherein during preparing the dispersion A, carboxymethylcellulose is dissolved in the solvent as a dispersing agent.
12. The process according to any one of the above items 6 to 11, wherein the fine fibrous carbon is a fibrous carbon produced by a disproportionation reaction of carbon monoxide.
13. The process according to any one of the above items 6 to 12, wherein the (b) fibrous carbon having a diameter of 100 nm or more is a multilayer carbon nanotube synthesized by vapor phase growth.
14. The process according to any one of the above items 6 to 13, wherein the (c) non-fibrous conductive carbon is selected from the group consisting of Ketjen Black (registered trademark, from Ketjen Black International Company), acetylene black, and SUPER P (registered trademark, from TIMCAL Graphite & Carbon Inc.), SUPER S, KS-4 and KS-6 (these are tradenames, from TIMCAL Graphite & Carbon Inc.).
15. The electrode for a lithium-ion battery according to any one of the above items 1 to 5, wherein the (a) fine fibrous carbon is produced by vapor phase growth, in which

a graphite-net plane consisting solely of carbon atoms forms a temple-bell-shaped structural unit comprising closed head-top part and body-part with open lower-end, where an angle θ formed by a generatrix of the body-part and a fiber axis is less than 15°,

2 to 30 of the temple-bell-shaped structural units are stacked sharing a common central axis to form an aggregate, and

the aggregates are connected in head-to-tail style with a distance to form the fiber.

16. The process according to any one of the above items 6 to 14, wherein the (a) fine fibrous carbon is produced by vapor phase growth, in which

a graphite-net plane consisting solely of carbon atoms forms a temple-bell-shaped structural unit comprising closed head-top part and body-part with open lower-end, where an angle θ formed by a generatrix of the body-part and a fiber axis is less than 15°,

2 to 30 of the temple-bell-shaped structural units are stacked sharing a common central axis to form an aggregate, and

the aggregates are connected in head-to-tail style with a distance to form the fiber.

### EFFECT OF THE INVENTION

According to the present invention, there is provided an electrode for a lithium-ion battery having a small electrode surface resistance, an improved discharge capacity and excellent cycle properties. This is supposed to be because the fine fibrous carbon is, as an electrical conducting material, uniformly dispersed in the electrode, and therefore it contributes to improvement in conductivity and uniformity of an electrode potential, simultaneously with the aid of the coexisting (b) fibrous carbon having a diameter of 100 nm or more and/or (c) non-fibrous conductive carbon,

### BRIEF DESCRIPTION OF THE DRAWINGS

FIG. 1(a) is a drawing schematically showing a minimal structural unit (temple-bell-shaped structural unit) constituting a fine carbon fiber; and FIG. 1(b) is a drawing schematically showing an aggregate consisting of 2 to 30 stacked temple-bell-shaped structural units.

FIG. 2(a) is a drawing schematically showing connecting aggregates with a certain distance to form a fiber; FIG. 2(b) is a drawing schematically showing curved connection when aggregates are connected with a certain distance.

FIG. 3 is a TEM image of the fine carbon fiber produced in Reference Example 1.

FIG. 4 is a TEM image of the fine carbon fiber produced in Reference Example 2.

FIG. 5 is a schematic drawing showing that a fine carbon fiber is pulled out to form a fine short carbon fiber by shear stress.

FIG. 6 is a TEM image of a fine short carbon fiber formed by shortening in Reference Example 3.

FIG. 7 is a TEM image of a fine short carbon fiber formed by shortening in Reference Example 3 as in FIG. 6.

FIG. 8 is a graph showing relationship between a mixing ratio of fine fibrous carbon (a) to fibrous carbon (b) and an electrode surface resistance (Table 1).

FIG. 9 is a graph showing relationship between a mixing ratio of fine fibrous carbon (a) to fibrous carbon (b) and a discharge capacity and cycle properties (Table 1).

FIG. 10 is an SEM image of the electrode surface of Example 1-2.

FIG. 11 is a graph showing relationship between a mixing ratio of fine fibrous carbon (a) to fibrous carbon (b) and an electrode surface resistance (Table 2).

FIG. 12 is a graph showing relationship between a mixing ratio of fine fibrous carbon (a) to fibrous carbon (b) and a discharge capacity and cycle properties (Table 2).

FIG. 13 is a graph showing relationship between a mixing ratio of fine fibrous carbon (a) to conductive carbon (c) and an electrode surface resistance (Table 3).

FIG. 14 is a graph showing relationship between a mixing ratio of fine fibrous carbon (a) to conductive carbon (c) and a discharge capacity and cycle properties (Table 3).

FIG. 15 is a graph showing relationship between a mixing ratio of fibrous carbon (b) to conductive carbon (c) and an electrode surface resistance (Table 4).

FIG. 16 is a graph showing relationship between a mixing ratio of fibrous carbon (b) to conductive carbon (c) and a discharge capacity and cycle properties (Table 4).

### MODE FOR CARRYING OUT THE INVENTION

An electrode for a lithium-ion battery of the present invention contains fine fibrous carbon (a) as an electrical conducting material and further at least one of (b) a fibrous carbon having a diameter of 100 nm or more and (c) a non-fibrous conductive carbon. First, these carbon materials will be described.

<Fine Fibrous Carbon (a)>

(a) A fine fibrous carbon having a diameter, which denotes an outer diameter, of less than 100 nm used in the present invention (that is, fine fibrous carbon (a)) is carbonaceous or graphitic, preferably highly graphitic for being electrochemically stable and exhibiting good conductivity. In general, these fibrous carbons are collectively called as “carbon nanotube” or “carbon nanofiber”, and among these, fine fibrous carbon (a) is a thin fibrous carbon having a fiber diameter of less than 100 nm. More particularly, representative fine carbon fibers have a fiber structure such as a multilayer or single-layer cylindrical tube type (carbon nanotube (narrow definition)), a fish bone type (cup stack type) and a card-shaped (platelet) type. Preferred are a fine carbon fiber containing a temple-bell-shaped structural unit and a fine short carbon fiber formed by shortening the fine carbon fiber as detailed below.

Fine fibrous carbon (a) used in the present invention can be formed by arc discharge, laser vapor deposition, vapor phase growth (gas phase growth) or the like. Vapor phase growth includes a variety of methods such as a CVD method using a catalyst in a fluidized or fixed bed, decomposition of an alcohol over a catalyst and a disproportionation reaction of carbon monoxide using a catalyst. Fibrous carbons having various shapes can be produced by a variety of manufacturing processes. These fine fibrous carbons can be used as they are, or can be used after removing a catalyst metal remaining within and/or on the fine fibrous carbon.

A fibrous carbon used in the present invention has a diameter of less than 100 nm, preferably 5 nm to 20 nm, further preferably 8 nm to 15 nm. A length of the fiber is 20 nm to 1 μm, preferably 50 nm to 400 nm.

An aspect ratio of the fiber is preferably 5 to 20. Therefore, the most preferable fibrous carbon has a diameter of 8 nm to 15 nm and a length of 40 nm to 300 nm.

<A Fine Carbon Fiber Having a Temple-Bell-Shaped Structural Unit and a Fine Short Carbon Fiber Formed by Shortening it>

There will be described, as the most preferable fine fibrous carbon (a), a fine carbon fiber having a temple-bell-shaped structural unit and a fine short carbon fiber formed by shortening it. In the following paragraphs, unless otherwise clearly indicated, a “fine carbon fiber” means a fine carbon fiber having a temple-bell-shaped structural unit as detailed below and a “fine short carbon fiber” means a fiber formed by shortening the “fine carbon fiber”.

Fine fibrous carbon (a) is most preferably a fine carbon fiber prepared by a disproportionation reaction of carbon monoxide among various vapor phase growth methods. In this manufacturing process, a carbon yield to a catalyst is high and consequently, the resulting fine fibrous carbon contains a smaller amount of a catalyst metal. Furthermore, its structure provides good balance between conductivity in a long-axis direction and conductivity of adjacent materials (the fine carbon fiber or other materials) and allows for easy dispersion. Therefore, it is most preferable as a fine fibrous carbon fiber in the present invention. Furthermore, the fine fibrous carbon prepared by a disproportionation reaction of carbon monoxide can be further shortened by pulverization for use.

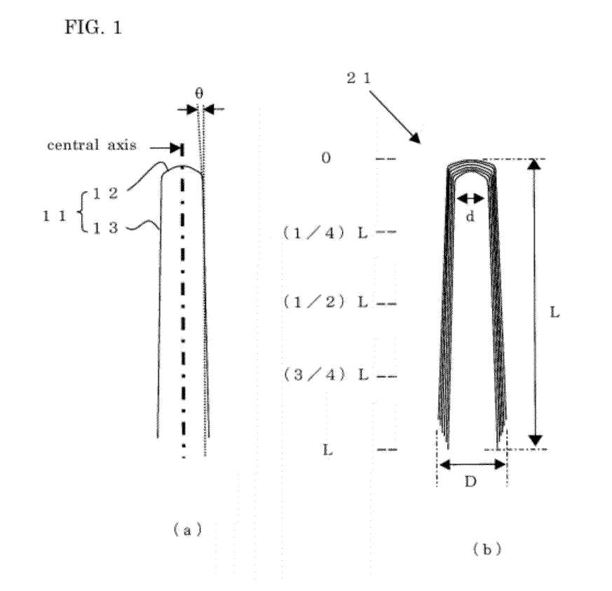

A fine carbon fiber and a fine short carbon fiber of this type has a temple-bell-shaped structure as shown in FIG. 1(a) as a minimal structural unit. A temple bell is commonly found in Japanese temples, which has a relatively cylindrical-shaped body-part, which is different from a Christmas bell that is very close to cone-shape. As shown in FIG. 1(a), a structural unit 11 has a head-top part 12 and a body-part 13 having an open end like a temple bell and approximately has a shape as a body of rotation formed by rotation about a central axis. The structural unit 11 is constituted by a graphite-net plane consisting solely of carbon atoms, and the circumference of the open-end of the body-part is the open end of the graphite-net plane. Here, although the central axis and the body-part 13 are, for convenience, indicated by a straight line in FIG. 1(a), they are not necessarily straight, but may be curved as shown in FIGS. 3, 4, 5 and 6 described later.

The body-part 13 is gradually enlarged toward the open-end side, and as a result, the generatrix of the body-part 13 is slightly oblique to the central axis of the temple-bell-shaped structural unit and an angle formed θ by these is less than 15°, more preferably 1°<θ<15°, further preferably 2°<θ<10°. With an excessively large θ, a fine fiber constituting from the structural units has a structure like a fish bone carbon fiber, leading to deterioration in conductivity in a fiber axis direction. On the other hand, with a smaller θ, it has a structure like a cylindrical tube and thus the open end of the graphite-net plane constituting the body-part in the structural unit are less exposed in the outer circumference surface of the fiber, leading to deterioration in conductivity between adjacent fibers.

The fine carbon fiber and the fine short carbon fiber have defects and irregular disturbances, but when their shape is observed as a whole neglecting such irregularity, it can be the that they have a temple-bell-shaped structure where the body-part 13 is gradually enlarged toward the open end side. In terms of a fine short carbon fiber and a fine carbon fiber of the present invention, the above description does not mean that θ is within the above range in all parts, but means that when the structural unit 11 is observed as a whole neglecting defects and irregular parts, θ generally is within the above range. Therefore, in determination of θ, it is preferable to eliminate an area near the head-top part 12 where a thickness of the body-part irregularly varies. More specifically, for example, when a length of a temple-bell-shaped structural unit aggregate 21 (see, the description below) is “L” as shown in FIG. 1(b), θ may be measured at three points (¼)L, (½)L and (¾)L from the head-top part side and an average of the measured values is determined and the average may be regarded as θ for the whole structural unit 11. “L” is ideally measured in a straight line, but actually, the body-part 13 is often curved, and therefore, it can be measured along the curve in the body-part 13 to give a substantially more real value.

When produced as a fine carbon fiber (the same goes for a fine short carbon fiber), the head-top part has a shape which is smoothly connected to the body-part and convexly curved to the upper side (in the figure). A length of the head-top part is typically about “D” (see FIG. 1(b)) or less, sometimes about “d” (see FIG. 1(b)) or less, wherein “D” and “d” will be described for a temple-bell-shaped structural unit aggregate.

Furthermore, as described later, active nitrogen is not used as a starting material, so that other atoms such as nitrogen are not contained in the graphite-net plane of the temple-bell-shaped structural unit. Thus, the fiber exhibits excellent crystallinity.

In a fine carbon fiber and a fine short carbon fiber used in the present invention, as shown in FIGS. 1(b), 2 to 30 of such temple-bell-shaped structural units are stacked sharing a central axis, to form a temple-bell-shaped structural unit aggregate 21 (hereinafter, sometimes simply referred to as an “aggregate”). The stack number is preferably 2 to 25, more preferably 2 to 15.

An outer diameter “D” of the body-part of the aggregate 21 is 5 to 40 nm, preferably 5 to 30 nm, further preferably 5 to 20 nm. A diameter of a fine fiber increases as “D” increases, so that in a composite with a polymer, a large amount needs to be added for giving particular functions such as conductivity. On the other hand, as “D” decreases, a diameter of a fine fiber decreases, so that fibers tend to more strongly agglomerate each other, leading to, for example, difficulty in dispersing them in preparation of a composite with a polymer. A body-part outer diameter “D” is determined preferably by measuring it at three points (¼)L, (½)L and (¾)L from the head-top part of the aggregate and calculating an average. Although FIG. 1(b) shows a body-part outer diameter “D” for convenience sake, an actual “D” is preferably an average of the measured values at the above three points.

An inner diameter “d” of the body-part of the aggregate is 3 to 30 nm, preferably 3 to 20 nm, further preferably 3 to 10 nm. Again, a body-part inner diameter “d” is determined preferably by measuring it at three points (¼)L, (½)L and (¾)L from the head-top part of the temple-bell-shaped structural unit aggregate and calculating an average. Although FIG. 1(b) shows a body-part inner diameter “d” for convenience sake, an actual “d” is preferably an average of the measured values at the above three points.

An aspect ratio (L/D) calculated from a length “L” of the aggregate 21 and a body-part outer diameter “D” is 2 to 150, preferably 2 to 30, more preferably 2 to 20, further preferably 2 to 10. With a larger aspect ratio, a fiber formed has a structure of a more cylindrical tube and conductivity in a fiber axis direction in a single fiber is improved, but the open ends of the graphite-net planes constituting the body-part of the structural units are less frequently exposed in the circumferential surface of the fiber, leading to deterioration in conductivity between adjacent fibers. On the other hand, with a smaller aspect ratio, the open ends of the graphite-net planes constituting the body-part of the structural units are more frequently exposed in the circumferential surface of the fiber, so that conductivity between adjacent fibers can be improved, but a fiber circumferential surface is constituted by a number of connected short graphite-net planes in a fiber axis direction, leading to deterioration in conductivity in a fiber axis direction in a single fiber.

The fine carbon fiber and the fine short carbon fiber share an essentially common configuration for a temple-bell-shaped structural unit and a temple-bell-shaped structural unit aggregate, but a fiber length is different as described below.

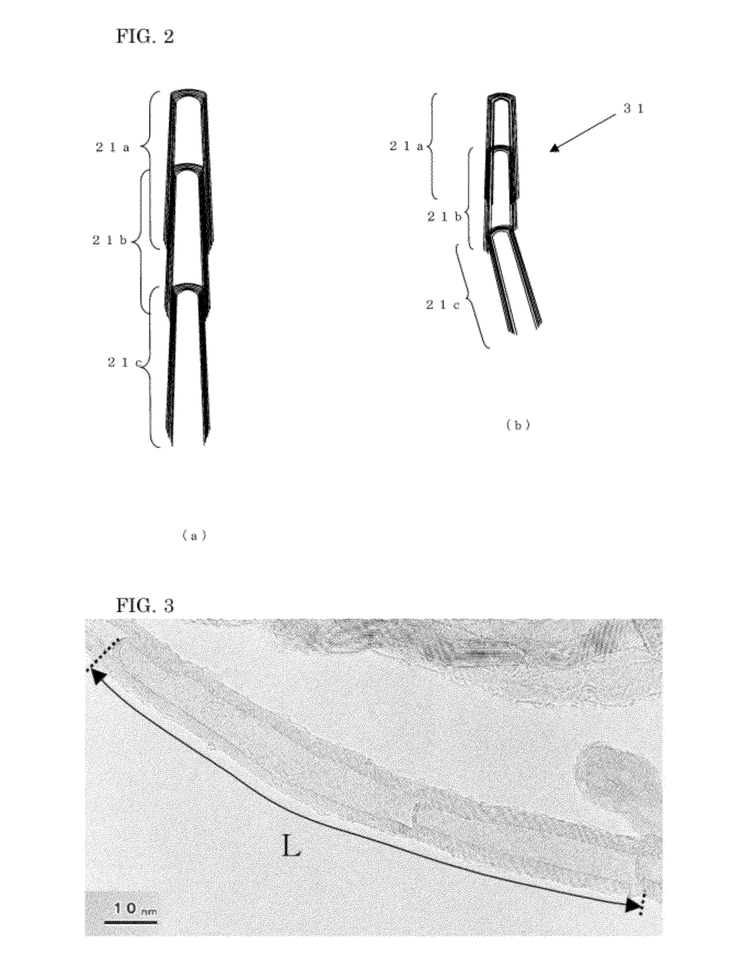

First, the fine carbon fiber is formed by connecting the aggregates in a head-to-tail style as shown in FIG. 2(a). A head-to-tail style means that in a configuration of the fine carbon fiber, a bonding site between adjacent aggregates is formed from a combination of the head-top part (head) of one aggregate and the lower end (tail) of the other aggregate. As a specific style of bonding the part, the head-top part of the outermost temple-bell-shaped structural unit in the second aggregate 21b is inserted into the inner part of the innermost temple-bell-shaped structural unit at a lower opening of a first aggregate 21a; and furthermore, the head-top part of a third aggregate 21c is inserted into the lower opening of a second aggregate 21b, and a number of such combinations are serially connected to form a fiber.

Each bonding part forming one fine fiber of the fine carbon fibers does not have structural regularity; for example, a length of a bonding part between a first aggregate and a second aggregate in a fiber axis direction is not necessarily equal to a length of a bonding part between the second aggregate and a third aggregate. Furthermore, as shown in FIG. 2(a), two aggregates bonded share a common central axis and may be connected in a straight line, but as in the temple-bell-shaped structural unit aggregates 21b and 21c shown in FIG. 2(b), they may be bonded without sharing a central axis, resulting in a curved structure in the bonding part. A length “L” of the temple-bell-shaped structural unit aggregate is approximately constant in each fiber. However, since in vapor phase growth, starting materials and byproduct gaseous components and a catalyst and a solid product component exist in mixture, a temperature distribution may occur in a reaction vessel; for example, a local site at a temporarily higher temperature generates depending on a flowing state of the above heterogeneous reaction mixture of a gas and a solid during an exothermic carbon precipitating reaction, possibly resulting in variation in a length “L” to some extent.

In the fine carbon fiber thus constituted, at least some of the open ends of the graphite-net planes in the lower end of the temple-bell-shaped structural units are exposed in the fiber circumferential surface, depending on a connection distance of the aggregates. Consequently, without conductivity in a fiber axis direction in a single fiber being deteriorated, conductivity between adjacent fibers can be improved due to jumping effect by n-electron emission (tunnel effect) as described above. Such a fine carbon fiber structure can be observed by a TEM image. Furthermore, it can be believed that the effects of a fine carbon fiber are little affected by curving of the aggregate itself or curving of the connection part of the aggregates. Therefore, parameters associated with a structure can be determined by observing an aggregate having a relatively straight part in a TEM image, as the structural parameters (0, D, d, L) for the fiber.

Next, a fine short carbon fiber is prepared by further shortening the fine carbon fiber thus formed. Specifically, shear stress is applied to the fine carbon fiber, to cause sliding between graphite fundamental planes in the aggregate bonding part, so that the fine carbon fiber is shortened at some of the bonding parts of the aggregates to give a shorter fiber. The fine short carbon fiber formed by such fiber shortening is as short as a fiber length of 1 to about several ten aggregates (that is, 100 or less, up to about 80, preferably up to about 70), preferably one to 20 aggregates which are connected. An aspect ratio of the aggregates in this fine short carbon fiber is about 2 to 150. An aspect ratio of the aggregates in the fine short carbon fiber which is suitable for mixing is 2 to 50. Even when shear stress is applied, cleavage does not occur in a fiber straight body-part of the fiber consisting of carbon SP2 bonds in the aggregate, so that the fiber cannot be cut into a unit smaller than an aggregate.

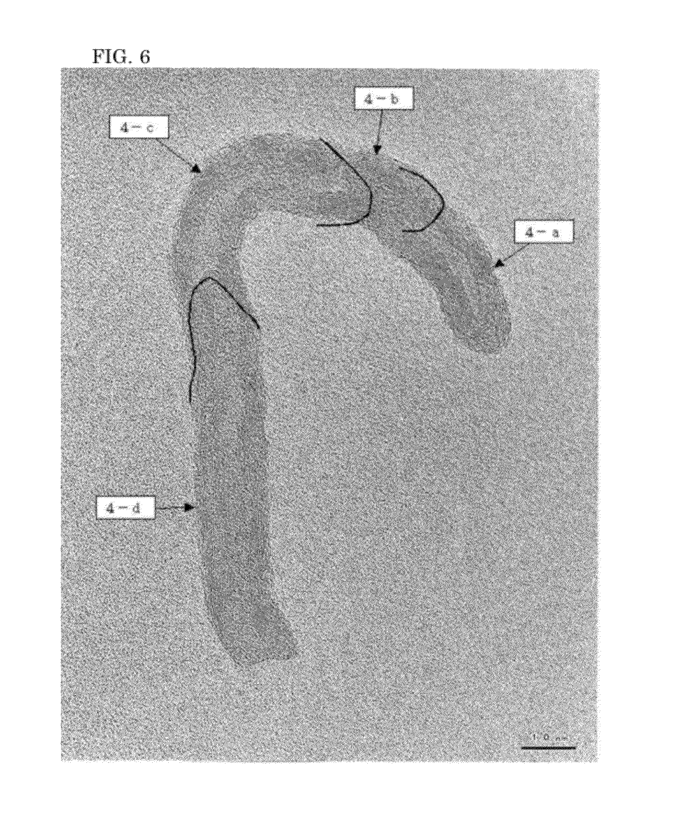

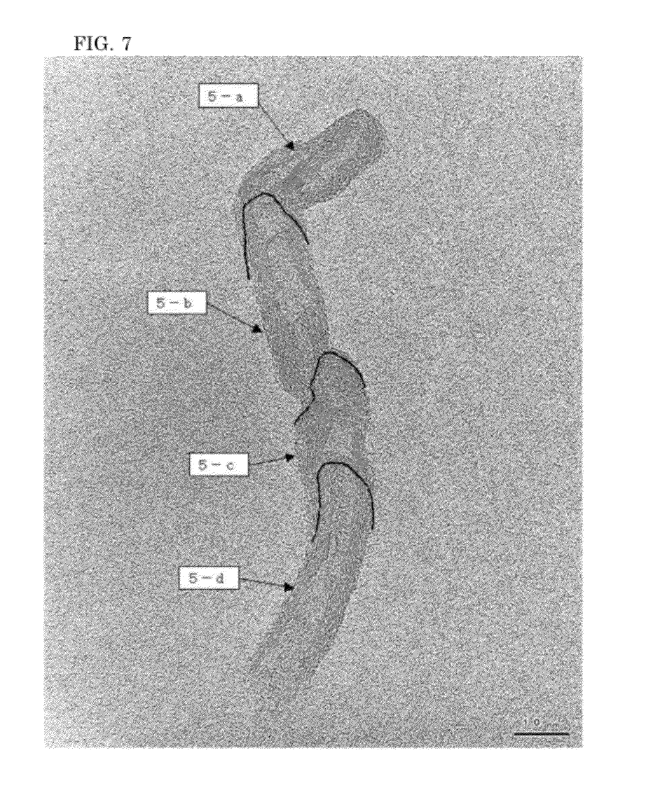

Also in the fine short carbon fiber, since the end surface of the graphite net is exposed, conductivity between adjacent fibers is as high as a fine carbon fiber before fiber shortening due to jumping effect by π-electron emission (tunnel effect) as described above while conductivity in a fiber axis in a single fiber is not deteriorated. A structure of a fine short carbon fiber after fiber shortening as described above can be observed by a TEM image (see FIGS. 6 and 7). Furthermore, it can be believed that the effects of the fine short carbon fiber are little affected by curving of the aggregate itself or curving of the bonding part of the aggregates. In the fine short carbon fiber in FIG. 6, four temple-bell-shaped structural unit aggregates of 4-a to 4-d are connected as shown in the figure, and for each, θ and an aspect ratio (L/D) are 4-a: θ=4.8°, (L/D)=2.5; 4-b: θ=0.5°, (L/D)=2.0; 4-c: θ=4.5°, (L/D)=5.0; 4-d: θ=1.1°, (L/D)=5.5. In the fine short carbon fiber in FIG. 7, four temple-bell-shaped structural unit aggregates of 5-a to 5-d are connected as shown in the figure and for each, θ and an aspect ratio (L/D) are 5-a: θ=10°, (L/D)=4.3; 5-b: θ=7.1°, (L/D)=3.4;5-c: θ=9.5°, (L/D)=2.6; 5-d: θ=7.1°, (L/D)=4.3.

In XRD by Gakushin-method of a fine carbon fiber and a short carbon fiber, a peak half width W (unit: degree) of 002 plane measured is within the range of 2 to 4. If W is more than 4, graphite exhibits poor crystallinity and poor conductivity. On the other hand, if W is less than 2, graphite exhibits good crystallinity, but at the same time, fiber diameter becomes large, so that a larger amount is required for giving functions such as conductivity to a polymer.

A graphite plane gap d002 as determined by XRD using Gakushin-method of a fine carbon fiber and a short carbon fiber is 0.350 nm or less, preferably 0.341 to 0.348 nm. If d002 is more than 0.350 nm, graphite crystallinity is deteriorated and conductivity is reduced. On the other hand, a fiber of 0.341 nm is produced in a low yield in the production.

The ash content contained in the fine carbon fiber and the short carbon fiber is 4% by weight or less, and therefore, purification is not necessary for a common application. Generally, it is 0.3% by weight or more and 4% by weight or less, more preferably 0.3% by weight or more and 3% by weight or less. The ash content is determined from a weight of an oxide as a residue after combustion of 0.1 g or more of a fiber.

A short carbon fiber has a fiber length of preferably 100 to 1000 nm, more preferably 100 to 300 nm. A fine short carbon fiber having such a length in which a peak half width W (unit: degree) of the above 002 plane is 2 to 4 and a graphite plane gap d002 is 0.350 nm or less, preferably 0.341 to 0.348 nm is a novel fiber which is not known in the prior art.

There will be described a process for manufacturing a fine carbon fiber and a short carbon fiber. A fine short carbon fiber is produced by shortening a fine carbon fiber.

### Process for Manufacturing a Fine Carbon Fiber

First, a process for manufacturing a fine carbon fiber is as follows. Using a catalyst which is an oxide of cobalt having a spinel type crystal structure containing magnesium by substitution forming solid solution, vapor phase growth is conducted supplying a mixed gas containing CO and H₂ to the catalyst particles to produce a fine carbon fiber.

A spinel type crystal structure of cobalt where Mg is substituted forming solid solution is represented by MgₓCO₃₋ₓO_{y}. In this formula, x is a number indicating substitution of Co by Mg, and nominally, 0<x<3. Furthermore, y is a number selected such that electric charge of the whole formula becomes neutral, and is formally a number of 4 or less. That is, a spinel-type oxide of cobalt CO₃O₄ contains divalent and trivalent Co ions, and when divalent and trivalent cobalt ions are represented by Co^{II} and Co^{III}, respectively, a cobalt oxide having a spinel type crystal structure is represented by Co^{II}Co^{III}₂O₄. Both sites of Co^{II} and Co^{III} are substituted by Mg to form a solid solution. After the solid solution formation by substitution with Mg for Co^{III}, electric charge is kept to be neutral and thus y is less than 4. However, both x and y have a value within a range that a spinel type crystal structure can be maintained.

For the use as a catalyst, a solid solution range of Mg represented by x is preferably 0.5 to 1.5, more preferably 0.7 to 1.5. A solid solution amount as x of less than 0.5 results in poor catalyst activity, leading to production of a fine carbon fiber in a lower yield. If x is more than 1.5, it is difficult to produce a spinel type crystal structure.

A spinel-type oxide crystal structure of the catalyst can be confirmed by XRD, and a crystal lattice constant “a” (cubic system) is within the range of 0.811 to 0.818 nm, more preferably 0.812 to 0.818 nm. If “a” is small, substitutional solid solution formation with Mg is inadequate and catalyst activity is low. The above spinel-type oxide crystal having a lattice constant larger than 0.818 nm is difficult to produce.

We suppose that such a catalyst is suitable because solid solution formation by substitution with magnesium in the spinel structure oxide of cobalt provides a crystal structure as if cobalt is dispersedly placed in magnesium matrix, so that under the reaction conditions, aggregation of cobalt is inhibited.

A particle size of the catalyst can be selected as appropriate and for example, is 0.1 to 100 μm, preferably 0.1 to 10 μm as a median diameter.

Catalyst particles are generally placed on an appropriate support such as a substrate or a catalyst bed by an appropriate application method such as spraying, for use. Spraying catalyst particles on a substrate or catalyst bed can be conducted by directly spraying the catalyst particles or spraying a suspension of the particles in a solvent such as ethanol and then drying it to spray a desired amount.

It is also preferable that catalyst particles are activated before being reacted with a source gas. Activation is generally conducted by heating under a gas atmosphere containing H₂ or CO. Such activation can be conducted by diluting the above gas with an inert gas such as He and N₂ as necessary. A temperature at which activation is conducted is preferably 400 to 600° C., more preferably 450 to 550° C.

There are no particular restrictions to a reactor for vapor phase growth, which can be conducted using a reactor such as a fixed-bed reactor and a fluidized-bed reactor.

A mixed gas containing CO and H₂ is used as a source gas to be a carbon source in vapor-phase growth.

An addition concentration of H₂ gas {(H₂/(H₂+CO)} is preferably 0.1 to 30 vol %, more preferably 2 to 20 vol %. When the addition concentration is too low, cylindrical graphite net planes form a carbon-nanotube-like structure parallel to a fiber axis. On the other hand, if it is more than 30 vol %, the angle of the temple-bell-shaped structure oblique to the fiber axis of a carbon side peripheral surface becomes larger and similar to a fish-bone shape, leading to lower conductivity in a fiber direction.

The source gas can contain an inert gas. Examples of such an inert gas include CO₂, N₂, He and Ar. The inert gas is preferably contained in such an amount that it does not significantly reduce a reaction rate; for example, 80 vol % or less, preferably 50 vol % or less. Furthermore, a synthetic gas containing H₂ and CO or a waste gas such as a steel converter exhaust gas can be, as necessary, used after appropriate treatment.

A reaction temperature for conducting vapor-phase growth is preferably 400 to 650° C., more preferably 500 to 600° C. If a reaction temperature is too low, a fiber does not grow. On the other hand, if a reaction temperature is too high, an yield is reduced. A reaction time is, but not limited to, for example, 2 hours or more and about 12 hours or less.

In terms of a reaction pressure, vapor-phase growth can be conducted at an ambient pressure from the viewpoint of convenience of a reactor or operation, but as long as carbon growth of Boudouard equilibrium proceeds, the reaction can be conducted under the pressurized or reduced-pressure condition.

It has been demonstrated that according to this manufacturing process for a fine carbon fiber, an yield of a fine carbon fiber per a unit weight of the catalyst is considerably higher than that in a conventional manufacturing process. An yield of a fine carbon fiber according to this manufacturing process for a fine carbon fiber is 40 folds or more, for example 40 to 200 folds per a unit weight of the catalyst. As a result, a fine carbon fiber containing reduced amount of impurities and ash content as described above can be produced.

Although a process of forming the bonding part unique to the fine carbon fiber prepared by this manufacturing process for a fine carbon fiber is not clearly understood, it is speculated that balance between exothermic Boudouard equilibrium and heat removal by source-gas flowing causes variation of a temperature near the fine cobalt particles formed from the catalyst, so that carbon growth intermittently proceeds, resulting in formation of the bonding part. In other words, it is speculated that four processes: [1] formation of a head-top part of a temple-bell-shaped structure, [2] growth of a body-part in the temple-bell-shaped structure, [3] pause of growth due to temperature increase caused by the processes [1] and [2], and [4] cooling by a flowing gas, are repeated on fine catalyst particles, to form the bonding part unique to a fine carbon fiber structure.

### Manufacturing Process for a Fine Short Carbon Fiber

As described above, a fine carbon fiber can be produced. Next, a fine short carbon fiber can be produced by separating a fine carbon fiber to shorten it. Preferably, it is prepared by applying shear stress to the fine carbon fiber. Suitable examples of a specific fiber shortening method include those using a grinder, a tumbling ball mill, a centrifugal ball mill, a centrifugal planetary ball mill, a bead mill, a microbead mill, an attriter type high-speed ball mill, a rotating rod mill, a vibrating rod mill, a roll mill and a three-roll mill. The fiber shortening of the fine carbon fiber may be conducted in wet-process or dry-process. Wet fiber shortening may be conducted in the presence of either a resin or a resin and a filler. Since fine carbon fibers before fiber shortening aggregate like a fluff ball, the presence of a small medium capable of loosening such a ball can accelerate shreding and fiber shortening. Furthermore, coexistence of a fine filler allows for shortening of the fine carbon fiber and mixing and dispersing the filler can be conducted at the same time. An atmosphere in dry fiber shortening can be selected from an inert atmosphere or an oxidative atmosphere, depending on a purpose.

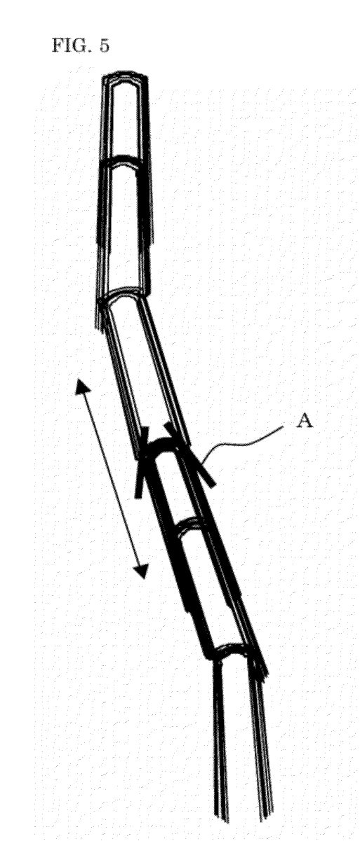

The reason why the fine carbon fiber can be easily shortened by applying shear stress is due to the structure of the fine carbon fiber. Specifically, it is because a fine carbon fiber is formed from temple-bell-shaped structural unit aggregates connected in a head-to-tail style with a distance. When shear stress is applied to the fiber, the fiber is pulled to the fiber axis direction indicated by an arrow in FIG. 5, and then sliding occurs between carbon fundamental planes constituting a bonding part (in FIG. 5, see region A: “two sticks” shape which is Japanese katakana “ha”), and one to several ten temple-bell-shaped structural unit aggregates are pulled off at the head-to-tail bonding parts, resulting in fiber shortening. That is, the head-to-tail bonding part is not formed by consecutive carbon double bonds in a fiber axis direction like a concentric fine carbon fiber, but formed by bonds mainly via van der Waals force with a lower bond energy. When crystallinity is compared between a fine carbon fiber and a fine short carbon fiber prepared by shortening the above fine carbon fiber on the basis of a carbon layer gap and a true specific gravity, difference is not observed in carbon crystallinity between these. However, in comparison with the fine carbon fiber, the fine short carbon fiber after fiber shortening has a larger surface area by about 2 to 5%. Increase of a surface area to this extent would be due to fiber shortening, indicating that shortening of a fine carbon fiber is caused by the pulling-off of the temple-bell-shaped structural unit aggregates simply from their bonding sites, while carbon crystallinity of the temple-bell-shaped structural unit aggregates in the fine carbon fiber is not deteriorated.

As described above, the fine carbon fiber used in the present invention has a part in which sliding at carbon fundamental planes in the carbon fiber easily occur and at which the separation by pulling off can be easily carried out. Therefore, the typical method of the present invention includes shortening the fine carbon fibers by applying shear stress beforehand, and preparing an electrode using the shortened fibers. A method of the present invention also includes a method comprising applying shear stress to the fine carbon fiber for shortening it successively during the preparation of slurry for an electrode, namely during the kneading with active material, binder, thickner and other conductive material, and thereafter preparing the electrode.

<Fibrous Carbon (b)>

In the present invention, (b) a fibrous carbon having a diameter, which denotes an outer diameter, of 100 nm or more (that is, fibrous carbon (b)) is carbonaceous or graphitic for being electrochemically stable and exhibiting good conductivity. A diameter of fibrous carbon (b) is preferably, but not limited to, 1 μm or less, more preferably 500 nm or less, further preferably 300 nm or less. Among fibrous carbons collectively called as “carbon nanotube” or “carbon nanofiber”, the fibrous carbon (b) is a thick fiber carbon having a diameter of 100 nm or more.

A fiber structure of fibrous carbon (b) can be, but not limited to, a multilayer cylindrical tube type (carbon nanotube (narrow definition)). It is prepared industrially preferably by vapor phase growth. An example of fibrous carbon (b) used in the present invention is VGCF® which is a carbon fiber formed by vapor phase growth and available from Showa Denko K.K.

### <Non-Fibrous Conductive Carbon>

In the present invention, (c) a non-fibrous conductive carbon used can be a carbon material generally used as an electrical conducting material, particularly a carbon material commonly added to a battery electrode. Examples can include carbon blacks such as Ketjen Black (registered trademark, from Ketjen Black International Company), acetylene black, and SUPER P (registered trademarks, from TIMCAL Graphite & Carbon Inc.), SUPER S, KS-4 and KS-6 (these three are tradenames, from TIMCAL Graphite & Carbon Inc.).

### <Electrode for a Lithium-Ion Battery>

As described above, an electrode for a lithium-ion battery of the present invention contains fine fibrous carbon (a) as an electrical conducting material and also at least one of fibrous carbon (b) and conductive carbon (c). Since even a low level of combination is effective as is demonstrated in Examples, a content of fine fibrous carbon (a) is more than 0% by weight and less than 100% by weight based on the total amount of electrical conducting materials. It is preferably 1% by weight to 99% by weight, further preferably 5% by weight to 95% by weight.

The following advantages are provided by combining fine fibrous carbon (a) with another conductive carbon having a different shape and different physical properties as described above. When fibrous carbon (b) is combined with fine fibrous carbon (a), fibrous carbon (b) having a larger fiber diameter considerably contributes to improvement in conductivity. For example, VGCF® has a fiber diameter of about 100 nm to 200 nm (for example, 150 nm) and exhibits higher conductivity because it has been graphitized. However, a larger fiber diameter means a smaller number of fibers as an electrical conducting material. Therefore, fibrous carbon (b) has no effect of homogenizing the electrode potential that is expected from the uniform dispersion of an electrical conducting material in the electrode. However, the electrode potential can be homogenized by combining fine fibrous carbon (a) which is uniformly dispersed within the electrode.

The following advantages are provided by combining fine fibrous carbon (a) with conductive carbon black having a structure like acetylene black as non-fibrous conductive carbon (c). Acetylene black has a structure in which more than ten particles having a single particle size of about 60 nm are connected in chains. Acetylene black itself is highly dispersible and highly conductive because it has been heated at an elevated temperature of about 2400° C. by the heat generated from an exothermic reaction during its production process. However, the effect of homogenizing an electrode potential is significantly improved by the presence of a fine fibrous carbon having a smaller fiber diameter.

As described above, a main effect of fine fibrous carbon (a) as an electrical conducting material is, in addition to improvement in conductivity by its sufficient dispersion, forming a homogeneous potential distribution within an electrode. In other words, it can ensure uniform charge transport to the whole active materials within the electrode, so that no active materials electrically isolated are present within the electrode. Furthermore, a homogeneous potential distribution is effective in that a region having an abnormally different potential which accelerates decomposition of an electrolyte is not formed. As a result, a lithium-ion battery can have an increased capacity and improved cycle properties and rate properties.

An electrode for a lithium-ion battery contains, in addition to the electrical conducting material defined in the present invention, a common electrode material such as an active material and a binder. In the present invention, both positive electrode and negative electrode can be constructed by the selection of an active material and other materials.

Examples of an active material for a negative electrode include graphite, crystalline carbon, isotropic carbon, titanium oxide, lithium titanium oxide, silicon, silicon-carbon mixed molding, lithium storage metals such as tin, tin compounds (SnM, M=Fe, Co, Mn, V, Ti), vanadium, silver, aluminum, zinc and bismuth. These can be used as a material for a negative electrode in a lithium-ion battery in any of various forms such as a fiber, a spherical molding and a crushed product.

Examples of an active material for a positive electrode include LiCoO₂, LiNiO₂, LiCrO₂, LiVO₂, LiMnO₂, LiMn₂O₄, LiFeO₂, LiTiO₂, LiScO₂, LiYO₂, LiFePO₄ and LiFe₂(SO₄)₃.

In terms of a binder, examples of a water-based binder include SBR latex, polyethylene oxide, polyvinyl alcohol and examples of a binding/dispersing agent (described later) include CMC and gelatin. An electrode for a lithium-ion battery can contain, if necessary, other materials. Other materials which can be contained can be partly added in the course of the manufacturing process described below.

### <Process for Manufacturing an Electrode for a Lithium-Ion Battery>

It is preferable that a fine fibrous carbon having a diameter of less than 100 nm (fine fibrous carbon (a)), and a fibrous carbon having a diameter of 100 nm or more (fibrous carbon (b)) and/or a non-fibrous conductive carbon (conductive carbon (c)) and other electrode materials such as an active material are mixed such that an electrical conducting material is dispersed as homogeneously as possible. For example, in preparing a coating slurry containing electrode materials for forming an electrode, fine fibrous carbon (a) is kneaded with an active material as a dispersion medium for being dispersed in the coating slurry. Here, it is preferable that fibrous carbon (b) and/or conductive carbon (c) are simultaneously kneaded, but these may be blended one by one separately by, for example, kneading.

Fine fibrous carbon (a) has a particularly large aspect ratio, and thus, when a slurry solvent is aqueous, fibers tend to agglomerate during drying. When excessive kneading is required for uniformly dispersing fine fibrous carbon (a) in an electrode, it causes problems of particle disruption of the active material and peeling of a surface-treated layer. However, a fine carbon fiber having a temple-bell-shaped structural unit and a fine short carbon fiber by shortening it which are preferable as fine fibrous carbon (a), particularly the fine short carbon fiber, are highly dispersible. Therefore, adequate dispersion can be generally achieved by kneading, but in order to dealing with the above problems, the following method is also suitable.

That is, a preferable manufacturing process comprises the steps of

dispersing fine fibrous carbon (a) in a solvent to prepare a dispersion solution A;

blending the dispersion solution A and an active material to prepare an electrode coating dispersion; and

applying the electrode coating dispersion.

A slurry solvent used in preparing the dispersion solution A may be water or an organic solvent; for example, water, NMP (n-methylpyrrolidone), methyl alcohol, ethyl alcohol, propanol, isopropanol, DMF (dimethylformamide) and mixtures of two or more of these. In the light of a smaller environmental load, water is most preferable.

In preparing the dispersion solution A, it is preferable to use a dispersing agent. A dispersing agent used is a substance having thickener and/or surfactant functions. Examples includes polysaccharides and monosaccharides such as CMC (carboxylmethylcellulose), hydroxyethylcellulose, KELCOGEL® (from CP Kelco Inc.), GELMATE® (from Dianippon Sumitomo Pharma Co., Ltd.), pectine, alginic acid, guar gum, locust bean gum, gum arabic, dextrin, altose, sorbit, lactose, rice starch and sucrose; sodium cholate, gelatin and polyvinyl alcohol; anionic surfactants such as naphthalenesulfonic acid-formaldehyde condensate and alkyl benzenesulfonates, cationic surfactants, nonionic surfactants, and polyether-modified silicone surfactants.

Among these, CMC, gelatin, water-soluble polysaccharides are preferable, and CMC is most preferable. It is also preferable to add, in addition to CMC, a dispersing agent acting as a surfactant such as anionic surfactant, cationic surfactants and nonionic surfactants.

These dispersing agents can be used when a slurry solvent is water, and can be also used when a slurry solvent is DMF, methanol, ethanol or NMP.

The dispersing agent added may also act as a binder (described above) for binding electrode materials, and therefore, at least a part of the dispersing agent may be at least a part of a binder.

The amount of a dispersing agent is preferably 1% by weight to 40% by weight to fine fibrous carbon (a). For achieving adequate effect of the dispersing agent, the amount is preferably 1% by weight or more, but an excessive amount may increase an electrode resistance and/or may leads to incorporation of electrochemically unstable components.

A dispersing method may be appropriately selected, in which a bead mill, a ultrasonic disperser or the like may be used.

Next, the dispersion solution A and an active material are blended to prepare an electrode coating dispersion. There are no particular restrictions to a blending method; for example, an active material and also, if necessary, a slurry solvent are added to the dispersion solution, and the mixture is kneaded. The timing of blending fibrous carbon (b) and/or conductive carbon (c) may be appropriately determined; they may be added simultaneously with blending the active material with the dispersion solution A, or they may be combined with the dispersion solution A before adding the active material, or they may be added together with fine fibrous carbon (a) in the course of preparing the dispersion solution A, or they may be added after blending the active material with the dispersion solution A, or alternatively they may be added portionwise at any appropriate time points described above. Furthermore, usually, the other additives such as a binder may be added simultaneously with the addition of the active material.

The electrode coating dispersion (slurry) thus obtained is applied on a collector, and is, in accordance with conventional processes, dried, optionally compressed and punched to give an electrode for a lithium-ion battery.

The electrode for a lithium-ion battery of the present invention can be applied to a known lithium-ion battery. For example, an electrolyte, an organic solvent, a separator, a battery structure and so on can be of materials and/or configurations known in the art.

### EXAMPLES

There will be described Examples of the present invention together with Comparative Examples.

### Reference Example 1

### Synthesis of a Fine Carbon Fiber

In 500 mL of ion-exchanged water were dissolved 115 g of cobalt nitrate [Co(NO₃)₂.6H₂O: molecular weight 291.03] (0.40 mol) and 102 g of magnesium nitrate [Mg(NO₃)₂.6H₂O: molecular weight 256.41] (0.40 mol), to prepare raw-material solution (1). Furthermore, 220 g of powdery ammonium bicarbonate [(NH₄)HCO₃: molecular weight 79.06] (2.78 mol) was dissolved in 1100 mL of ion-exchanged water, to prepare raw-material solution (2). Next, raw-material solutions (1) and (2) were mixed at a reaction temperature of 40° C., after which the mixture was stirred for 4 hours. The precipitate formed was filtered, washed and then dried.

The product was calcined and pulverized with a mortar to provide 43 g of a catalyst. A crystal lattice constant “a” (cubic system) of the spinel structure in this catalyst was 0.8162 nm, and a metallic element ratio in the spinel structure of the substitutional solid solution was Mg:Co=1.4:1.6.

A quartz reaction tube (inner diameter: 75 mmφ, height: 650 mm) was perpendicularly fixed and in its center was placed a support of silica wool on which was then dispersed 0.9 g of the catalyst. Under He atmosphere, the tube was heated to a furnace temperature of 550° C., and then a mixed gas consisting of CO and H₂ (volume ratio: CO/H₂=95.1/4.9) as a source gas was fed from the bottom of the reaction tube at a flow rate of 1.28 L/min for 7 hours, to synthesize a fine carbon fiber.

An yield was 53.1 g, and an ash content was determined as 1.5% by weight. A peak half width “W” (degree) observed in XRD analysis of the product was 3.156 and d002 was 0.3437 nm. Furthermore, from a TEM image, parameters related to the dimensions of temple-bell-shaped structural units constituting the fine carbon fiber obtained and the aggregate of these were D=12 nm, d=7 nm, L=114 nm, L/D=9.5, θ=0 to 7° (average: about 3)°. A stack number of the temple-bell-shaped structural units constituting the aggregate was 4 to 5. Here, D, d and θ were determined for three points (¼)L, (½)L and (¾)L from the head-top of the aggregate.

FIG. 3 shows a TEM image of the fine carbon fiber prepared in Referential Example 1.

### Reference Example 2

A catalyst was prepared as described in Reference Example 1, using 86 g of magnesium acetate [Mg(OCOCH₃)₂.4H₂O: molecular weight 214.45] (0.40 mol) in place of magnesium nitrate. A crystal lattice constant “a” (cubic system) of a spinel structure in the catalyst thus prepared was 0.8137 nm, and a metallic element ratio in the spinel structure of the substitutional solid solution was Mg: Co=0.8:2.2.

A quartz reaction tube (inner diameter: 75 mmφ, height: 650 mm) was perpendicularly fixed and in its center was placed a support of silica wool on which was then dispersed 0.6 g of the catalyst. Under He atmosphere, the tube was heated to a furnace temperature of 500° C., and then from the bottom of the reaction tube, H₂ was fed at a flow rate of 0.60 L/min for 1 hour to activate the catalyst. Then, under He atmosphere, the tube was heated to a furnace temperature of 590° C. and then a mixed gas consisting of CO and H₂ (volume ratio: CO/H₂=84.8/15.2) as a source gas was fed at a flow rate of 0.78 L/min for 6 hours, to synthesize a fine carbon fiber.

An yield was 28.2 g and an ash was 2.3% by weight. A peak half width “W” (degree) observed in XRD analysis of the product was 2.781 and d002 was 0.3425 nm. Furthermore, from a TEM image, parameters related to the dimensions of temple-bell-shaped structural units constituting the fine carbon fiber obtained and the aggregate of these were D=12 nm, d=5 nm, L=44 nm, L/D=3.7, θ=0 to 3° (average: about 2)°. A stack number of the temple-bell-shaped structural units constituting the aggregate was 13. Here, D, d and θ were determined for three points (¼)L, (½)L and (¾)L from the head-top of the aggregate.

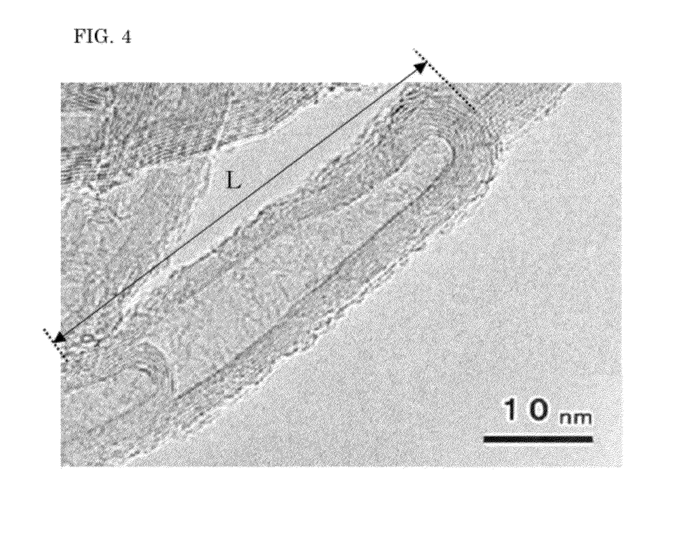

FIG. 4 shows a TEM image of the fine carbon fiber prepared in Referential Example 2.

### Reference Example 3

### Synthesis of a Fine Short Carbon Fiber

A fine carbon fiber was synthesized as described in Reference Example 1. An yield was 56.7 g, and an ash content was determined to be 1.4% by weight. The product had a peak half width W (degree) of 3.39 and a d002 of 0.3424 nm as observed by XRD analysis.

The fine carbon fibers thus obtained was treated by a ceramic ball mill with a diameter of 2 mm for a predetermined time to prepare a fine short carbon fiber. FIGS. 6 and 7 show TEM images of a fine short carbon fiber after 20 hours. From the TEM images in FIGS. 6 and 7, parameters related to the dimensions of temple-bell-shaped structural units constituting the fine short carbon fiber thus obtained and the aggregate of these were D=10.6 to 13.2 nm, L/D=2.0 to 5.5, θ=0.5° to 10°. Here, θ is an inclination average of the right and the left carbon layers to the center of the fiber axis in the TEM image. A stack number of the temple-bell-shaped structural units forming the aggregate was 10 to 20.

### Example 1

To 5 parts by weight of the fine carbon fiber synthesized in Reference Example 1 (fine fibrous carbon (a)), added was 1 part by weight of CMC1280 (from DAICEL Chemical Industries, Ltd.), and the mixture was dispersed in 100 parts by weight of water using a ultrasonic disperser. The dispersion was a viscous slurry having black sheen. The slurry was diluted with water to give a brown transparent liquid, in which settling of the fibrous carbon was not observed at all, and no solids were observed on a 5C filter paper after direct filtration of the diluted solution. It can be, therefore, concluded that the fine carbon fiber is uniformly dispersed in this aqueous dispersion.

To this dispersion solution A(slurry) containing the fine carbon fiber and CMC, added was VGCF (registered trademark, from Showa Denko K.K.) (fibrous carbon (b)) varying its proportion to prepare a mixed slurry of electrical conducting materials. The mixed slurry in an amount that contains the electrical conducting material to be 5 parts by weight was blended with 93 parts by weight of LiFePO₄ whose surface was carbon-coated as an active material, and then a deficient amount of CMC was added such that the CMC amount in the solid content of the electrode was to be 1% by weight, and then water was added such that the solid content was to be 39% by weight. The mixture was kneaded for 20 min by a centrifugal kneader from Nippon Seiki Co., Ltd., and then SBR latex binder was added in an amount of 1 part by weight based on the solid content of the electrode and then the mixture was kneaded for 2 min to prepare an electrode coating dispersion (slurry).

The electrode slurry was applied on a PET film and an aluminum foil to a thickness of 150 μm. After drying, the electrode coated on the aluminum foil was punched into a 16 mm circular electrode, from which a half cell was assembled using metal lithium as a counter electrode. The cell was tested for a discharge capacity, rate properties and cycle properties of a positive electrode. An electrolyte was a solution of 30 vol % ethylene carbonate and 70 vol % of ethyl methyl carbonate containing 1 mol/L of LiPF₆ as a solute.

Varying a ratio of the fine carbon fiber and VGCF® in the mixed slurry of electrical conducting materials, tests were conducted and the results are shown in Table 1.

### Comparative Example 1

An electrode was prepared, a battery was assembled and battery evaluation was conducted as described in Example 1, except that VGCF® was not added and the dispersion solution A in Example 1 was used alone as an electrical conducting material. The battery evaluation results are shown in Table 1.

### Comparative Example 2

An electrode was prepared, a battery was assembled and battery evaluation was conducted as described in Example 1, except that VGCF® was used alone as an electrical conducting material. The battery evaluation results are shown in Table 1.

TABLE 1

| | Proportion of | | Electrode | | 20 C | 2 C capacity |
|---|---|---|---|---|---|---|
| | a fine fibrous | Proportion of | surface | 2 C discharge | discharge | holding ratio at |
| | carbon fiber | VGCF | resistance | capacity | capacity | 200 cycles |
| | wt % | wt % | kΩ/□ | mAh/g | mAh/g | % |
| Comparative | 100 | 0 | 0.41 | 150 | 75 | 92 |
| Example 1 | | | | | | |
| Example 1-1 | 90 | 10 | 0.23 | 152 | 82 | 95 |
| Example 1-2 | 80 | 20 | 0.18 | 153 | 80 | 96 |
| Example 1-3 | 60 | 40 | 0.11 | 152 | 80 | 95 |
| Example 1-4 | 40 | 60 | 0.17 | 151 | 80 | 94 |
| Example 1-5 | 20 | 80 | 0.30 | 140 | 68 | 89 |
| Comparative | 0 | 100 | 0.65 | 133 | 35 | 83 |
| Example 2 | | | | | | |

Note)
Weight ratio of electrode solids; C—LiFePO₄:electrical conducting material:CMC:SBR = 93:5:1:1.

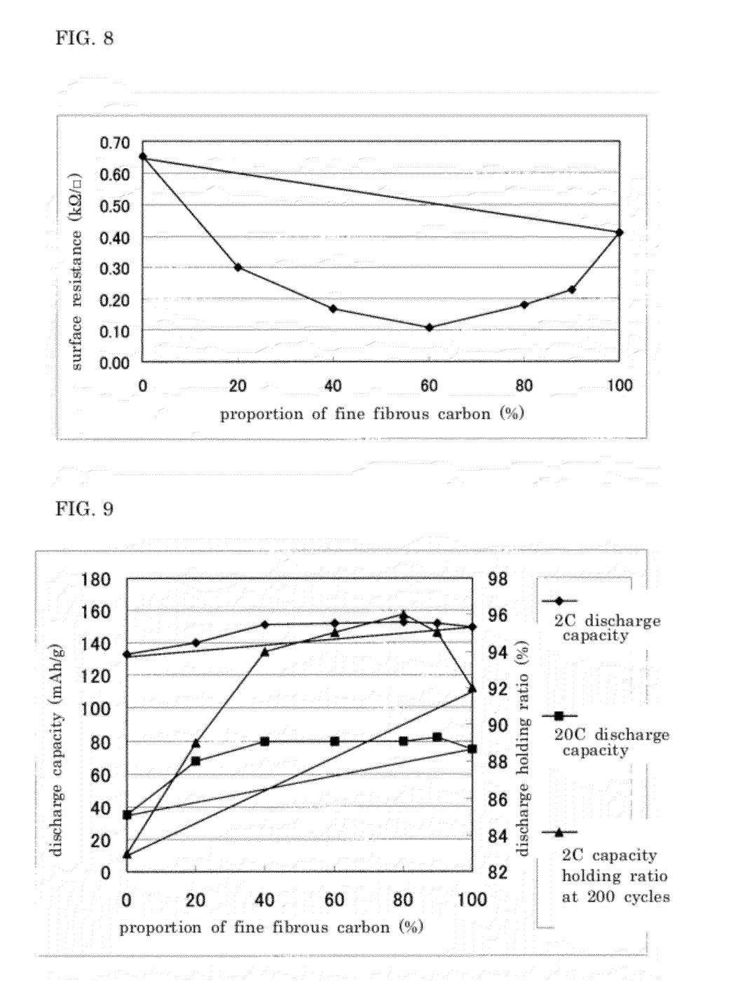

The electrode surface resistance in Table 1 is plotted in FIG. 8 and the discharge capacity and cycle properties are plotted in FIG. 9. In FIG. 8, 0% in the horizontal axis means VGCF® 100%. If it is a simple blending, a surface resistance is generally on a straight line connecting a surface resistance at VGCF® 100% and a surface resistance at fine fibrous carbon 100%. However, a surface resistance of the mixture is below the straight line as shown in FIG. 8, indicating that these are synergistically effective by blending.

FIG. 9 also demonstrates that all of a 2C discharge capacity a 20C discharge capacity and a 200 cycle capacity holding ratio are on the straight line connecting VGCF® 100% and fine fibrous carbon 100% and that a discharge capacity is increased and cycle properties are improved, indicating significant synergetic effect.

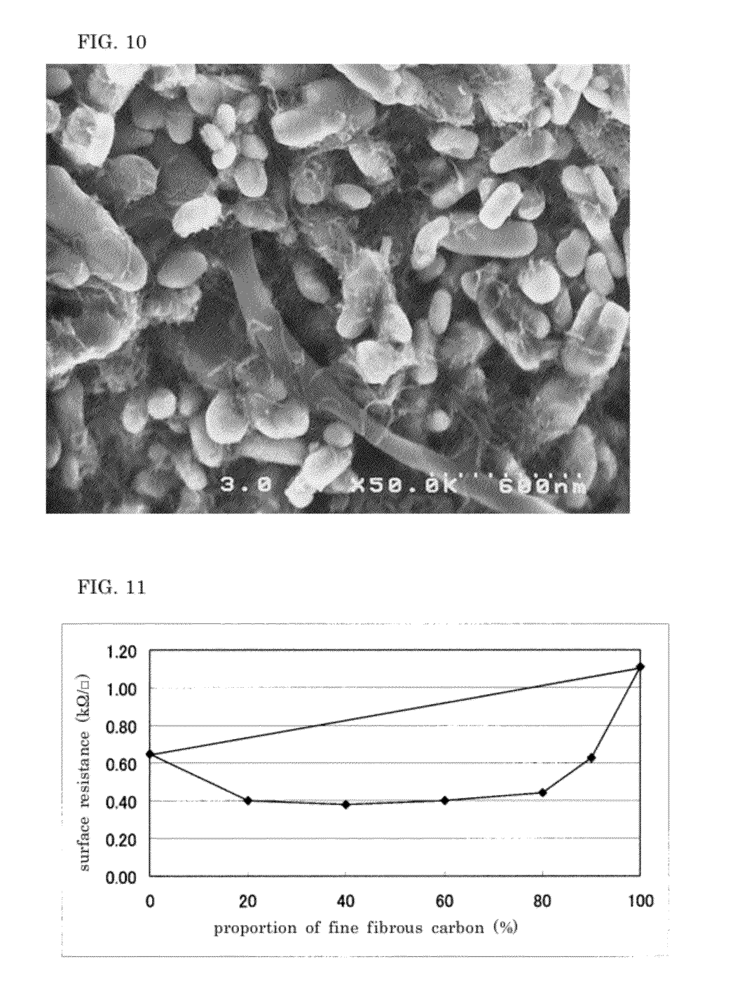

FIG. 10 shows an SEM image of an electrode surface of Example 1-2 described in Table 1. As seen in FIG. 10, fine fibrous carbons are uniformly and highly dispersed on the surfaces of oval LiFePO₄ of the active material and VGCF and adhere to them like a net. The fine fibrous carbons suppose to contribute to averaging a potential between LiFePO₄ particles by forming a number of conductive circuits between VGCF and LiFePO₄ and between LiFePO₄ particles.

### Example 2

The fine short carbon fiber (a ball milling time was 6 hours) prepared in Reference Example 3 was blended in a powder state with VGCF® in a predetermined ratio. Then, an electrode was produced as described in Example 1. Using the electrode produced, a half cell was assembled as described in Example 1, and then a discharge capacity, rate properties and cycle properties of a positive electrode were tested.

Varying a ratio of the fine carbon fiber and VGCF®, tests were conducted and the results are shown in Table 2.

### Comparative Example 3

An electrode was produced as described in Example 1, using the fine short carbon fiber (a ball milling time was 6 hours) prepared in Reference Example 3 alone as an electrical conducting material, and a battery was assembled and evaluated. The evaluation results of the battery are shown in Table 2.

TABLE 2

| | Proportion of a | | Electrode | 2 C | 20 C | 2 C capacity |
|---|---|---|---|---|---|---|
| | fine fibrous | Proportion of | surface | discharge | discharge | holding ratio |
| | carbon fiber | VGCF | resistance | capacity | capacity | at 200 cycles |
| Test No. | wt % | wt % | kΩ/□ | mAh/g | mAh/g | % |
| Comparative | 100 | 0 | 1.11 | 144 | 69 | 90 |
| Example 3 | | | | | | |
| Example 2-1 | 90 | 10 | 0.63 | 146 | 76 | 93 |
| Example 2-2 | 80 | 20 | 0.44 | 146 | 73 | 94 |
| Example 2-3 | 60 | 40 | 0.40 | 144 | 73 | 91 |
| Example 2-4 | 40 | 60 | 0.38 | 142 | 72 | 90 |
| Example 2-5 | 20 | 80 | 0.40 | 139 | 61 | 86 |
| Comparative | 0 | 100 | 0.65 | 133 | 35 | 83 |
| Example 2 | | | | | | |

Note)
Weight ratio of electrode solids; C—LiFePO4:electrical conducting material:CMC:SBR = 93:5:1:1.

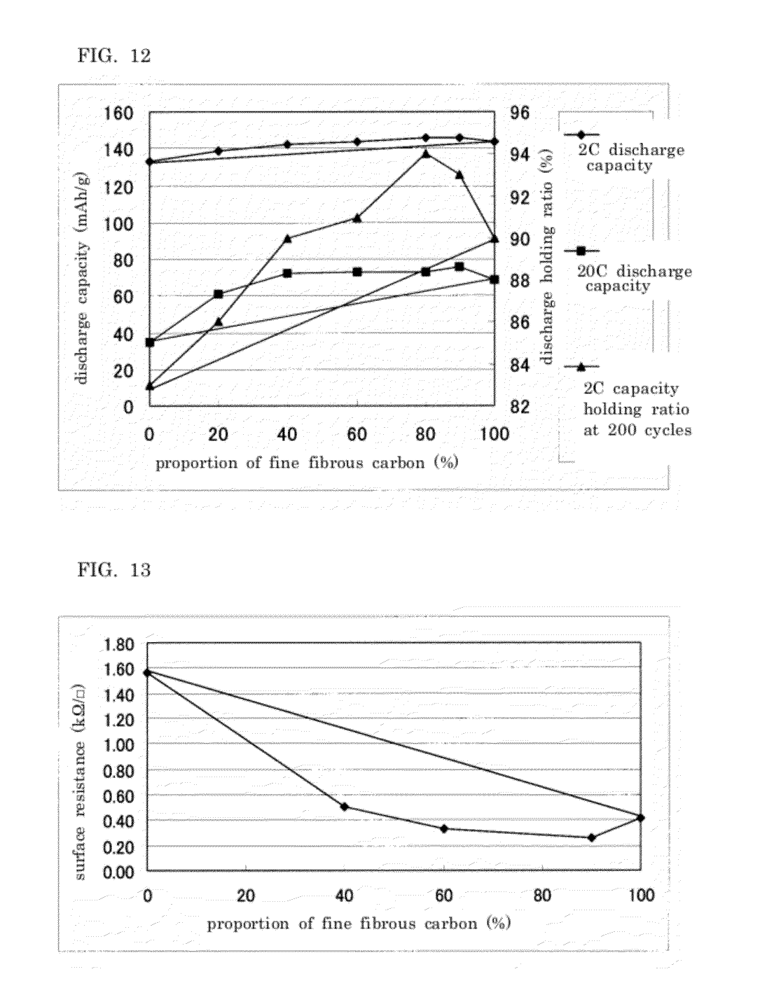

The electrode surface resistance in Table 2 is plotted in FIG. 11, and the discharge capacity and cycle properties are plotted in FIG. 12. FIGS. 11 and 12 demonstrate that powder blending of the fine short carbon fiber and VGCF® is also significantly synergistically effective in reduction in a surface resistance, increase in a discharge capacity and improvement in cycle properties of the electrode.

### Example 3

An electrode slurry was prepared as described in Example 1, except that the dispersion solution A used in Example 1 and acetylene black (from DENKI KAGAKU KOGYO KABUSHIKI KAISHA) were blended, and then an electrode was produced and tested for a discharge capacity, rate properties and cycle properties of a positive electrode as described in Example 1.

Varying a ratio of the fine carbon fiber and acetylene black, tests were conducted and the results are shown in Table 3.

### Comparative Example 4

An electrode was produced as described in Example 1, using acetylene black used in Example 3 alone as an electrical conducting material, and a battery was assembled and evaluated. The evaluation results of the battery are shown in Table 3.

TABLE 3

| | Proportion of a | Proportion of | Electrode | 2 C | 20 C | 2 C capacity |
|---|---|---|---|---|---|---|
| | fine fibrous | acetylene | surface | discharge | discharge | holding ratio |
| | carbon fiber | black | resistance | capacity | capacity | at 200 cycles |
| Test No. | wt % | wt % | kΩ/□ | mAh/g | mAh/g | % |
| Comparative | 100 | 0 | 0.41 | 150 | 75 | 92 |
| Example 1 | | | | | | |
| Example 1-1 | 90 | 10 | 0.26 | 147 | 74 | 93 |
| Example 1-3 | 60 | 40 | 0.33 | 147 | 73 | 93 |
| Example 1-4 | 40 | 60 | 0.51 | 142 | 71 | 92 |
| Comparative | 0 | 100 | 1.56 | 130 | 33 | 85 |
| Example 4 | | | | | | |

Note)
Weight ratio of electrode solids; C—LiFePO4:electrical conducting material:CMC:SBR = 93:5:1:1.

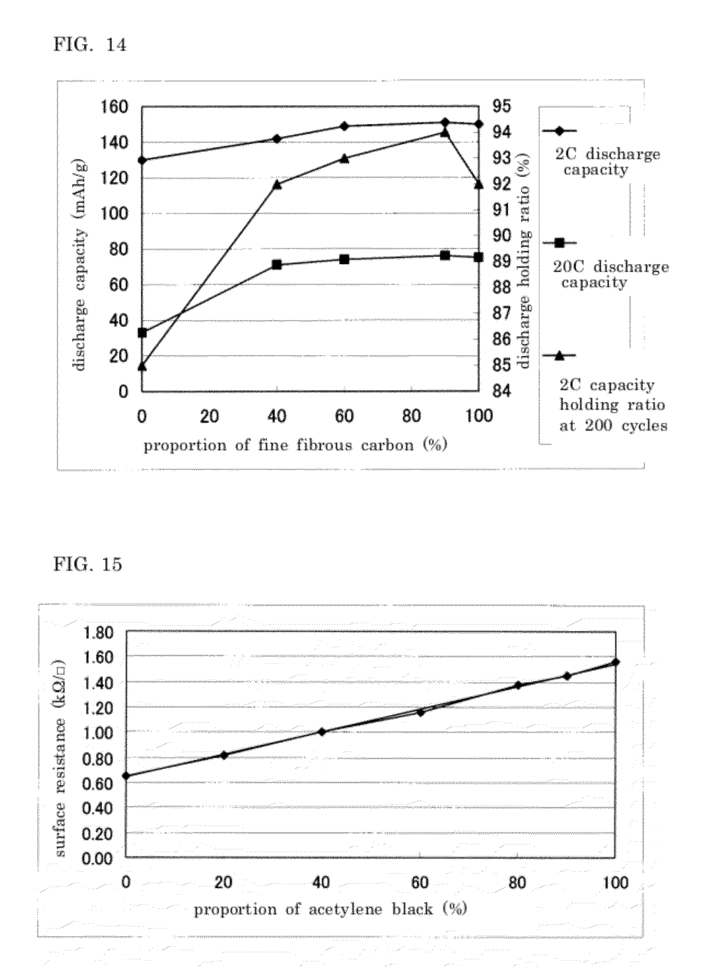

The electrode surface resistance in Table 3 is plotted in FIG. 13, and the discharge capacity and cycle properties are plotted in FIG. 14. FIGS. 13 and 14 also demonstrate that blending of acetylene black and the fine fibrous carbon is significantly synergistically effective in considerable reduction in a surface resistance, increase in a discharge capacity and improvement in cycle properties.

### Comparative Example 5

An electrode was produced as described in Example 1, using VGCF® used in Examples 1 and 2 and acetylene black used in Example 3 as an electrical conducting material, and a battery was assembled and evaluated. The evaluation results of the battery are shown in Table 4.

TABLE 4

| | Proportion of | | Electrode | 2 C | 20 C | 2 C capacity |
|---|---|---|---|---|---|---|
| | acetylene | Proportion of | surface | discharge | discharge | holding ratio |
| | black | VGCF | resistance | capacity | capacity | at 200 cycles |
| Test No. | wt % | wt % | kΩ/□ | mAh/g | mAh/g | % |
| Comparative | 100 | 0 | 1.56 | 130 | 33 | 85 |
| Example 4 | | | | | | |
| Comparative | 90 | 10 | 1.45 | 131 | 34 | 85 |
| Example 5-1 | | | | | | |
| Comparative | 80 | 20 | 1.38 | 130 | 35 | 85 |
| Example 5-2 | | | | | | |
| Comparative | 60 | 40 | 1.16 | 129 | 32 | 83 |
| Example 5-3 | | | | | | |
| Comparative | 40 | 60 | 1.00 | 130 | 31 | 84 |
| Example 5-4 | | | | | | |
| Comparative | 20 | 80 | 0.82 | 132 | 33 | 84 |
| Example 5-5 | | | | | | |
| Comparative | 0 | 100 | 0.65 | 133 | 35 | 83 |
| Example 2 | | | | | | |

Note)
Weight ratio of electrode solids; C—LiFePO4:electrical conducting material:CMC:SBR = 93:5:1:1.

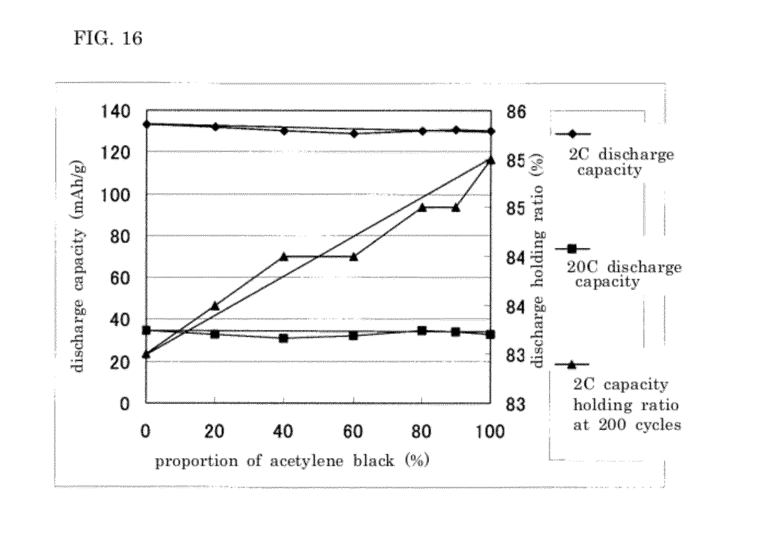

The electrode surface resistance in Table 4 is plotted in FIG. 15, and the discharge capacity and cycle properties are plotted in FIG. 16. FIGS. 15 and 16 demonstrate that blending of acetylene black and VGCF® conventionally used is slightly, but not significantly, synergistically effective in reduction in a surface resistance, increase in a discharge capacity and improvement in cycle properties.

### INDUSTRIAL USABILITY

According to the present invention, there is provided an electrode for a lithium-ion battery with a small electrode surface resistance, an improved discharge capacity and excellent cycle properties.

### DESCRIPTION OF SYMBOLS

11: structural unit
12: head-top part
13: body-part
21, 21a, 21b, 21c: aggregate

1-16. (canceled)

17. An electrode for a lithium-ion battery comprising, as an electrical conducting material,
(a) a fine fibrous carbon having a diameter of less 100 nm, and
(b) a fibrous carbon having a diameter of 100 nm or more and/or
(c) a non-fibrous conductive carbon.

18. The electrode for a lithium-ion battery according to claim 17, wherein the (b) fibrous carbon having a diameter of 100 nm or more is a multilayer carbon nanotube synthesized by vapor phase growth.

19. The electrode for a lithium-ion battery according to claim 17, wherein the (c) non-fibrous conductive carbon is selected from the group consisting of Ketjen Black (registered trademark, from Ketjen Black International Company), acetylene black, and SUPER P(registered trademark, from TIMCAL Graphite & Carbon Inc.), SUPER S, KS-4 and KS-6 (these three are tradenames, from TIMCAL Graphite & Carbon Inc.).

20. The electrode for a lithium-ion battery according to claim 17, wherein a diameter of the (a) fine fibrous carbon is 5 to 20 nm.

21. The electrode for a lithium-ion battery according to claim 17, wherein the (a) fine fibrous carbon is a fibrous carbon produced by a disproportionation reaction of carbon monoxide.

22. A process for manufacturing an electrode for a lithium-ion battery, comprising mixing an electrical conducting material containing
(a) a fine fibrous carbon having a diameter of less than 100, and
(b) a fibrous carbon having a diameter of 100 nm or more and/or
(c) a non-fibrous conductive carbon,
with an active material.

23. The process according to claim 22, wherein the process comprises
a step of producing the electrode using the (a) fine fibrous carbon having a diameter of less than 100 nm, wherein the (a) fine fibrous carbon is a short-fibered carbon prepared by applying shear stress, and/or
a step of shortening the (a) fine fibrous carbon having a diameter of less than 100 nm successively by applying shear stress during preparation an electrode slurry including the (a) fine fibrous carbon having a diameter of less than 100 nm by kneading.

24. The process according to claim 22, comprising the steps of
dispersing the (a) fine fibrous carbon having a diameter of less than 100 nm in a solvent to prepare a dispersion solution A;
blending the dispersion solution A and an active material to prepare an electrode coating dispersion, wherein the (b) fibrous carbon having a diameter of 100 nm or more and/or the (c) non-fibrous conductive carbon are contained in the dispersion solution, and/or mixed during preparing the electrode coating dispersion; and
applying the electrode coating dispersion.

25. The process according to claim 24, wherein the solvent is water.

26. The process according to claim 24, wherein the solvent is an organic solvent.

27. The process according to claim 24, wherein during preparing the dispersion A, carboxymethylcellulose is dissolved in the solvent as a dispersing agent.

28. The process according to claim 22, wherein the fine fibrous carbon is a fibrous carbon produced by a disproportionation reaction of carbon monoxide.

29. The process according to claim 22, wherein the (b) fibrous carbon having a diameter of 100 nm or more is a multilayer carbon nanotube synthesized by vapor phase growth.

30. The process according to claim 22, wherein the (c) non-fibrous conductive carbon is selected from the group consisting of Ketjen Black (registered trademark, from Ketjen Black International Company), acetylene black, and SUPER P (registered trademark, from TIMCAL Graphite & Carbon Inc.), SUPER S, KS-4 and KS-6 (these are tradenames, from TIMCAL Graphite & Carbon Inc.).

31. The electrode for a lithium-ion battery according to claim 17, wherein the (a) fine fibrous carbon is produced by vapor phase growth, in which
a graphite-net plane consisting solely of carbon atoms forms a temple-bell-shaped structural unit comprising closed head-top part and body-part with open lower-end, where an angle θ formed by a generatrix of the body-part and a fiber axis is less than 15°,
2 to 30 of the temple-bell-shaped structural units are stacked sharing a common central axis to form an aggregate, and
the aggregates are connected in head-to-tail style with a distance to form the fiber.

32. The process according to claim 22, wherein the (a) fine fibrous carbon is produced by vapor phase growth, in which
a graphite-net plane consisting solely of carbon atoms forms a temple-bell-shaped structural unit comprising closed head-top part and body-part with open lower-end, where an angle θ formed by a generatrix of the body-part and a fiber axis is less than 15°,
2 to 30 of the temple-bell-shaped structural units are stacked sharing a common central axis to form an aggregate, and
the aggregates are connected in head-to-tail style with a distance to form the fiber.
